(19) United States
(12) Patent Application Publication
(10) Pub. No.: US 2008/0148138 A1
(43) Pub. Date: Jun. 19, 2008

(54) Method, Apparatus and System for Providing Display Information to an End-User Display Device

(75) Inventor: Carlton J. Sparrell, Marblehead, MA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/612,042

(22) Filed: Dec. 18, 2006

(51) Int. Cl. G06F 17/00

(52) U.S. Cl. 715/201

(57) ABSTRACT

A device and method for providing display information blended or combined with multimedia content to an end user display device. The method includes receiving multimedia content, determining display points or other triggering events in the multimedia content, executing one or more display applications to access or generate display information, and blending or combining the display information, e.g., in a user-configurable format, with the multimedia content for transfer to an end user display device. The device includes a processor for receiving and processing multimedia content, a display application manager for accessing or generating display information, and a blender for blending or combining the display information with the multimedia content for transfer to an end user display device. The device identifies display points or other locations in the multimedia content suitable for blending the display information therewith.

### BACKGROUND OF THE INVENTION

1. Field of the Invention

The invention relates to providing displaying information to an end user display device, such as a television or computer monitor. More particularly, the invention relates to displaying information, in a user-configurable format, non-intrusively on an end user display device.

2. Description of the Related Art

Increasingly, consumer end users want to be constantly connected to information, such as news, weather, stock-quotes, sports scores and personal messages. As more and more consumer end-user devices become connected, display techniques are evolving for conveniently and non-intrusively communicating such desired information to the end user. For example, cellular telephones and other mobile devices can include a service/application developed by Motorola, Inc., Screen3™, which provides an “idle screen” that can scroll abbreviated forms of information on the phone display for a user to either glance at during free moments or otherwise ignore as desired. If a particular portion of abbreviated information, such as a news headline, attracts the attention of the end user, the end user can click a button or perform some other function to receive more detailed information.

Personal desktop computers and related devices have similar capabilities available for providing so-called “dashboard” information. For example, Widget Engine (formerly Konfabulator), offered by Yahoo!, allows an end user to download and install one or more mini-applications (“widgets”) that run in the computer's background. Example applications include stock tickers, web-based news feeds, weather forecast icons and personal “to do” lists. An end user can easily ignore these background application displays, or glance at them to quickly obtain the provided information. Also, many of these mini-applications allow an end user to click on the display for more detailed information.

With respect to televisions and other displays used with video processing devices, e.g., video converter/decoder (set-top box) devices, incorporating abbreviated information can be slightly more challenging. Many television channels already consume display screen space with their own information tickers, e.g., stock tickers, news tickers, sports score tickers. Moreover, many channels also include other information on the display screen, such as clocks and alerts. One approach to providing abbreviated information to a video processing device display screen is to reduce the size of the overall screen viewing area, e.g., with a picture in graphics display. However, such an approach can be relatively intrusive to the viewing experience of the end user.

### BRIEF DESCRIPTION OF THE DRAWINGS

FIG. 1 is a block diagram of a video processing device for use in a system for displaying display information on an end user display device;

FIG. 2 is a flow chart that schematically illustrates a method for displaying display information on an end user display device; and

FIG. 3 is a block diagram of the screen of an end user display device in a system and method for displaying display information on an end user display device.

### DETAILED DESCRIPTION

In the following description, like reference numerals indicate like components to enhance the understanding of the methods, apparatus and systems for displaying display information on an end user display through the description of the drawings. Also, although specific features, configurations and arrangements are discussed hereinbelow, it should be understood that such specificity is for illustrative purposes only. A person skilled in the relevant art will recognize that other steps, configurations and arrangements are useful without departing from the spirit and scope of the invention.

The methods and system devices described herein involve the non-intrusive blending or combining of display information with multimedia content for display on an end user display device, e.g., in a user-configurable format. Display information is data obtained from a third party information source. The display information can include news headline indicators, weather forecast icons, stock ticker information, sports scores and other information, personal message indicators, and other suitable display information. The display information can be combined non-intrusively with multimedia content or other information received from a multimedia content source in response to triggering events, such as the transition to and from commercials, or display points that can be encoded or otherwise included in the multimedia content or initiated by the end user. The display information can be combined with the real time display of multimedia content or with the “live” time-shifted display of buffered multimedia content.

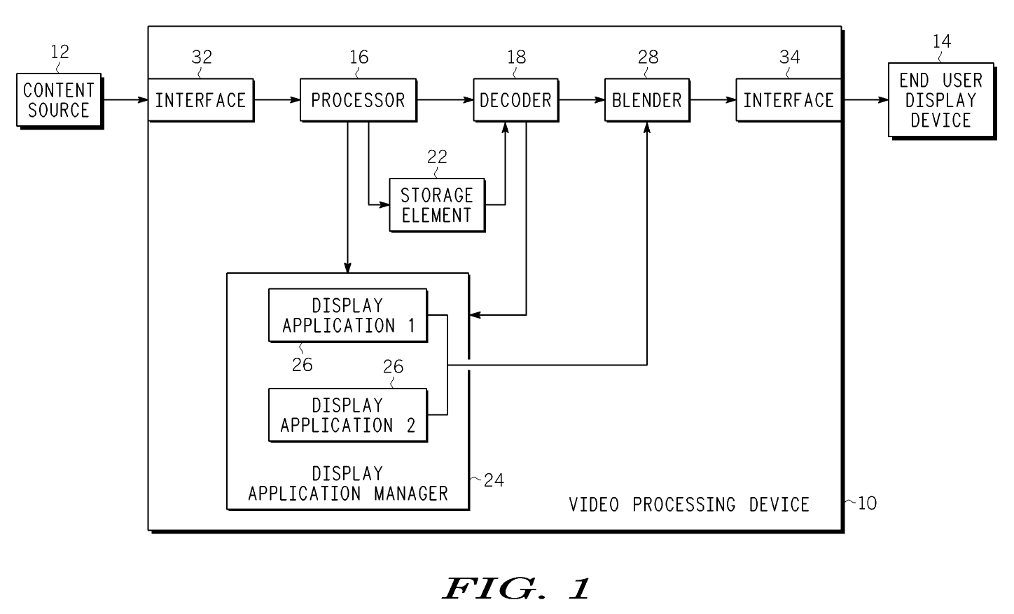

Referring now to FIG. 1, shown is a block diagram of a video processing device 10 for use in a system for displaying display information, e.g., in a user-configurable format, on an end user display device. The video processing device 10 can be partially or completely any suitable device or subsystem (or portion thereof) for receiving multimedia content from a content source 12 and/or transmitting or transferring processed multimedia content, including display information, to an end user display device 14, such as a television, a computer monitor or other suitable display device. The multimedia content can be any suitable multimedia content, including movies, programming events and other multimedia content that is distributed, e.g., as one or more programming streams from a broadcast source or other suitable multimedia content source.

Suitable video processing devices include any multimedia content viewing, processing and/or storing device, such as any digital video recorder (DVR) or digital video server (DVS) device, including signal converter or decoder (set-top) boxes with internal and/or external recording capabilities and local and/or remote storage, which often are referred to as personal video recorder (PVR) devices. Other suitable video processing devices include a residential gateway, a home media server system, a digital video disk recorder, a computer, a television with built-in or added-on video content receiving and storing capability, or other suitable computing devices or video devices, including internet protocol (IP), satellite and cable digital video recorders, and home area network (HAN) devices and systems.

The video processing device 10 includes a processor or processing unit 16, a decoder 18 coupled to the processor 16, and a content storage element or device 22 coupled to the processor 16. The video processing device 10 also includes a display application manager or managing device 24 coupled to the processor 16. The display application manager 24 can include one or more display applications 26, as will be discussed in greater detail hereinbelow.

The video processing device 10 also includes a blender or blending device 28 coupled to the display application manager 24. The blender 28 also typically is coupled to the processor 16 either directly or, alternatively, via the decoder 18, as shown. The processor 16 and other components in the video processing device 10 are coupled between a first or input interface 32, which receives multimedia content from the content source 12, and a second or output interface 34, which transfers processed multimedia content, including stored multimedia content and/or display information, to the end user display 14.

One or more of the processor 16, the decoder 18, the content storage device 22, the display application manager 24, the blender 28 and the interfaces 32, 34 can be comprised partially or completely of any suitable structure or arrangement, e.g., one or more integrated circuits. Also, it should be understood that the video processing device 10 includes other components, hardware and software (not shown) that are used for the operation of other features and functions of the video processing device 10 not specifically described herein.

The video processing device 10 can be partially or completely configured in the form of hardware circuitry and/or other hardware components within a larger device or group of components. Alternatively, the video processing device 10 can be partially or completely configured in the form of software, e.g., as processing instructions and/or one or more sets of logic or computer code. In such configuration, the logic or processing instructions typically are stored in a data storage device, e.g., the content storage device 22 or other suitable data storage device (not shown). The data storage device typically is coupled to a processor or controller, e.g., the processor 16, or other suitable processor or controller (not shown). The processor accesses the necessary instructions from the data storage device and executes the instructions or transfers the instructions to the appropriate location within the video processing device 10.

The content storage device 22 can be any suitable information storage unit, such as any suitable magnetic storage or optical storage device, including magnetic disk drives, magnetic disks, optical drives, optical disks, and memory devices, including random access memory (RAM) devices, and flash memory. Also, although the content storage device 22 is shown within the video processing device 10, the content storage device 22 can be located external to the video processing device 10 and suitably coupled thereto.

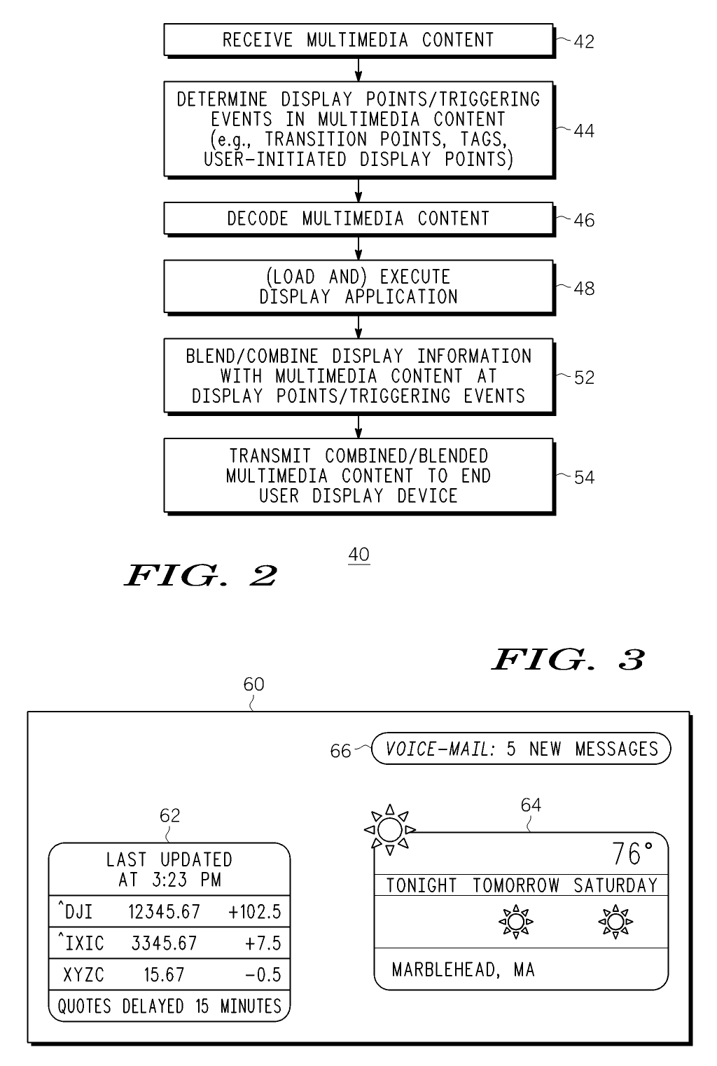

Referring now to FIG. 2, with continuing reference to FIG. 1, shown is a flow chart that schematically illustrates a method 40 for displaying display information on an end user display device. The method 40 includes a step 42 of receiving multimedia content, e.g., by the video processing device 10. The multimedia content, which typically is transmitted from an appropriate content source, e.g., the content source 12, typically is received by the video processing device 10 by the input interface 32 and transferred to the processor 16.

As discussed generally hereinabove, multimedia content received by the video processing device 10 can be any suitable multimedia, audio and/or video content, including movies and programming events, from any suitable multimedia content source. The multimedia content received by the video processing device 10 typically is in the form of a multimedia video and/or audio stream comprised of a plurality of digital video and/or audio signals formatted according to a suitable standard, such as the Moving Pictures Experts Group (MPEG) 2 or MPEG 4 standard, and multiplexed into a data stream that is modulated on a carrier using quadrature amplitude modulation (QAM) or other suitable modulation technique.

The multimedia content typically is delivered to the video processing device 10 by a digital cable system, such as a Hybrid Fiber Coaxial (HFC) cable system, or other suitable content stream delivery system. The multimedia content stream also can be an analog video stream, or an Internet Protocol (IP) video stream transmitted over any suitable Fiber To The Premises (FTTP) system, such as Fiber To The Curb (FTTC) or Fiber To The Home (FTTH), or over any suitable number of digital subscriber line systems (xDSL). Alternatively, the multimedia content stream can be delivered to the video processing device 10 via a computer network or other suitable network, either through a wired connection or wirelessly. To receive such multimedia content, the video processing device 10 may include one or more receiving components (not shown), such as a radio frequency (RF) tuner, a QAM demodulator, an MPEG stream demultiplexor and a conditional access decryptor or decrypting module.

The method 40 includes a step 44 of identifying, locating or otherwise determining actual and/or potential display points or triggering events in the multimedia content received by the video processing device 10. Display points and triggering events can be identifiable start and stop locations or positions within the received multimedia content where display information is suitable to be blended with the multimedia content. For example, within a multimedia content stream, a transition to a commercial, e.g., a black frame in the multimedia content stream, can be a suitable display point or triggering event to start blending the display information with the multimedia content. In such case, the transition from the commercial (e.g., the next black frame) back to the multimedia content portion of the stream would be a suitable display point or trigger event to stop the display information from being blended with the multimedia content.

Alternatively, in addition to display points and triggering events that may occur naturally in the multimedia content stream, display points can be artificially inserted or encoded into the content stream, e.g., by the content provider. Such encoding would be performed, e.g., at the content source 12 or other suitable system location. For example, one or more tags or other suitable indicia can be encoded into the multimedia content stream prior to the stream being transmitted to the video processing device 10. The processor 16 and/or the display application manager 24 would be suitably configured to locate such tags within the content stream and identify the tags, e.g., as blending start points or blending stop points.

Also, alternatively, display points can be created in response to end user input and associated with specific locations or positions in the multimedia content. For example, if an end user is watching a “live” time-shifted broadcast of multimedia content, display information can be displayed whenever the end user pauses the time-shifted broadcast of the multimedia content. Also, if the end user wishes to continue viewing display information that has since been removed from or about to be removed from the display device, the end user may initiate an appropriate command, e.g., via a remote control device, to continue to display the display information, e.g., for a selected period of time or until such time that the end user no longer wishes to view the display information. In such case, the end user may initiate another command, e.g., via a remote control device, to end the display of the display information.

The method 40 can include a step 46 of decoding the multimedia content. Typically, in the decoding step 46, the decoder 18 decompresses the multimedia content to make it suitable for display, e.g., by the end user display device 14. After being decoded, the decompressed multimedia content is sent by the decoder 18 to the blender 28 or other appropriate component within the video processing device 10. Although the decoder 18 is shown coming after the processor 16 in the component arrangement of video processing device 10, it should be understood that the decoder 18 can come before the processor 16, i.e., the multimedia content can be decompressed prior to further processing.

The method 40 also includes a step 48 that can include loading one or more display applications and/or executing one or more display applications, e.g., to provide display information for blending with the multimedia content. The display application manager 24 generally is configured to be responsible for controlling which display applications are loaded on the video processing device 10, and when and how the display applications are executed to access or otherwise provide display information. Display applications typically include the executable software programs and/or other applications used to access, generate or otherwise provide display information. The display application manager 24 also controls the distribution of accessed or generated display information, e.g., to the blender 28 for blending or combining with the multimedia content to be displayed on the end user display device 14.

One or more display applications can be loaded on the video processing device 10 along with the multimedia content being received by the video processing device 10 from the content source 12. Alternatively, one or more display applications can be loaded onto the video processing device 10 independent of received multimedia content, e.g., either before and/or after receiving multimedia content. One or more display applications can be transmitted from the content source 12 to the video processing device 10, in which case the display applications typically are received by the processor 16 and transferred to the display application manager 24. Alternatively, one or more display applications can be transmitted to the video processing device 10 from some other suitable display application source (not shown). The transmitted display applications can be received by the display application manager 24 indirectly from the processor 16 or directly via a suitable connection between the display application source and the display application manager 24, including wirelessly from the display application source to the display application manager 24.

In addition to loading one or more display applications onto the video processing device 10, the step 48 includes executing one or more display applications, e.g., to provide display information for blending with portions of the multimedia content. Executing a display application allows the display application manager 24 to access a particular type of display information, e.g., a news headline ticker, from a suitable content source, such as the provider of the multimedia content or a web-based feed coupled to the multimedia content source 12 or coupled directly to the video processing device 10. Alternatively, the execution of one or more display applications can generate or access existing or previously generated graphics information to be used independent of or along with any accessed display information. For example, the display application manager 24 can generate or recall previously-stored weather forecast icons or other graphics information to be used with currently-accessed weather forecast information received by the video processing device 10 from an appropriate weather information feed.

It should be understood that the display application manager 24 can begin (or end) the execution of one or more display applications in response to specific commands from the processor 16, e.g., in response to the processor 16 locating or identifying display points and/or triggering events in the multimedia content. Alternatively, the display application manager 24 can begin (or end) the execution of one or more display applications in response to the display application manager 24 itself locating or identifying display points and/or triggering events in the multimedia content. Also, alternatively, the display application manager 24 can be running one or more display applications, e.g., continuously, in the background while the video processing device 10 is receiving and processing multimedia content. That is, the end user may want the application on or running continuously, under the control of the end user, and not in necessarily in response to any particular triggering event from the content source 12. Also, alternatively, the display application manager 24 can begin (or end) the execution of one or more display applications in response to an appropriate command from the end user, e.g., via a remote control device.

The method 40 also includes a step 52 of blending or combining display information with multimedia content. Typically, when the processor 16 or other suitable component determines an appropriate opportunity for displaying display information, e.g., upon the processor 16 identifying one or more display points in the multimedia content, the processor 16 informs the display application manager 24 of the display opportunity. Alternatively, the display application manager 24 is configured to determine appropriate display opportunities independent of the processor 16. In either event, upon the identification of an appropriate display opportunity, the display application manager 24 can enable the appropriate display information, including any graphics to be included as part of the display information, and communicates the display information to the blender 28.

The blender 28 combines or blends the display information with the decoded multimedia content, e.g., by displaying the display information along with the multimedia content. The resulting combined display information includes decoded multimedia content with display information. Alternatively, if the display information is displayed during a transition between content programs, the display information may be displayed by itself, i.e., without any multimedia content. The display information remains displayed until the appropriate command is received, e.g., from the processor 16 and/or the display application manager 24, to remove the display information and/or otherwise discontinue accessing and/or generating the display information.

The display information can be displayed and removed from display immediately upon the display application manager 24 receiving appropriate start and stop commands. Alternatively, the display application manager 24 can fade-in the display information when an appropriate start command is received and/or fade-out the display information when an appropriate stop command is received. In this manner, the display information may slightly overlap the display period defined by the start and stop commands. For example, display information that is blended with multimedia content might slowly fade out over a couple of seconds after the stop command is received.

The method 40 also includes a step 54 of transmitting the combined or blended display information to the end user display device 14. When the display information is combined with the decoded multimedia content, the combined or blended display information is transmitted to the end user display device 14, e.g., via the interface 34. Alternatively, when the display information is not combined with the decoded multimedia content, the video processing device 10 transmits decoded multimedia content to the end user display device 14, e.g., in a conventional manner.

For example, in operation, multimedia content received by the video processing device 10 is analyzed, e.g., by the processor 16. At the end of a video program segment, there is a black frame or other transition before a commercial. Upon detection of this transition point, the processor 16 instructs the display application manager 24 to access/generate appropriate display information and transfer the display information to the blender 28. Alternatively, the processor 16 and/or the display application manager 24 is continuously accessing or receiving, but not displaying, display information.

The blender 28 combines the display information with the multimedia content or otherwise displays the display information with the multimedia content. The blended or combined display information is transmitted to the end user display device 14. At the end of the transition or at the next transition point, e.g., at the end of the commercial, the display application manager 24 turns off or otherwise discontinues providing the display information to the blender 28. As the new video program segment begins, the display information is not part of the display information.

As discussed previously herein, the video processing device 10 can include a buffer or storage element 22 for storing multimedia content, e.g., for recording and playing back recorded multimedia content as part of a “live” time-shifting display of buffered multimedia content. Accordingly, the processor 16 can be configured to provide video processing functions in addition to those described hereinabove, such as indexing of multimedia content for trick play (e.g., pause, rewind and/or fast forward of buffered “live” multimedia content).

For multimedia content encoded according to MPEG and many other video encoding techniques, indexing can locate suitable start points in the content stream. Such start points can be used to restart playback. Also, the processor 16 or other appropriate component in the video processing device 10 can be configured to locate display points or triggering events, e.g., as discussed hereinabove. The display point locations are stored and used on playback of the buffered content.

To synchronize playback, the decoder 18 or other appropriate component can track the position of the buffered content being played back. The display application manager 24 then can be notified when a display point is encountered. For example, the decoder 18 can notify the display application manager 24 directly. Alternatively, the processor 16 or other appropriate component can look for display points in the content prior to the content being decoded, and notify the display application manager 24 when display points are encountered.

Also, the playback of buffered multimedia content can be modified, e.g., by the end user, to enhance the viewing experience. For example, if the transition between video program segments is too short for the end user to view the display information adequately, the end user can pause playback during the transition period to continue to view the display information. Thus, in effect, the transition point or period is extended sufficiently to allow the end user to view the display information as desired. Also, pausing “live” multimedia content can be used to insert extra time in a display period automatically, e.g., from one second to three seconds. Also, alternatively, as discussed hereinabove, the video processing device 10 can be configured to turn on the display information when the end user pauses playback, e.g., via a remote control device.

Referring now to FIG. 3, shown is a sample screen 60, e.g., from the end user display device 14, with display information from several display applications turned on and displayed. Although no multimedia content is shown, e.g., as between the end of a program segment and the start of a commercial, it should be understood that the display information can be blended and displayed along with multimedia content, e.g., as iconic displays on top of the multimedia content.

The sample screen 60 shows a stock ticker 62, a weather forecast 64 and a voice-mail indicator 66. It should be understood that other display information can be shown with or without such display information. Also, it should be understood that the display information 62, 64, and 66 can be variable in size and is not shown to scale within the sample screen 60. The end user can configure or reconfigure all or a part of the displayed display information. For example, the end user can have various display information displayed in various formats and/or in various positions on the screen.

As discussed herein, the apparatus 10 and method 30 for displaying display information on an end user display device involves the non-intrusive blending of display information with multimedia content for display on the end user display device. The display information can be blended with the multimedia content in response to suitable display points and/or triggering events identified by one or more processing components in the video processing device 10. Also, the display information display information can be blended with the real time display of multimedia content or with the “live” time-shifting display of buffered multimedia content.

The method shown in FIG. 2 may be implemented in a general, multi-purpose or single purpose processor. Such a processor will execute instructions, either at the assembly, compiled or machine-level, to perform that process. Those instructions can be written by one of ordinary skill in the art following the description of FIG. 2 and stored or transmitted on a computer readable medium. The instructions may also be created using source code or any other known computer-aided design tool. A computer readable medium may be any medium capable of carrying those instructions and includes random access memory (RAM), dynamic RAM (DRAM), flash memory, read-only memory (ROM), compact disk ROM (CD-ROM), digital video disks (DVDs), magnetic disks or tapes, optical disks or other disks, silicon memory (e.g., removable, non-removable, volatile or non-volatile), packetized or non-packetized wireline or wireless transmission signals.

It will be apparent to those skilled in the art that many changes and substitutions can be made to the methods, apparatus and systems for displaying display information on an end user display device herein described without departing from the spirit and scope of the invention as defined by the appended claims and their full scope of equivalents.

1. A computer program embodied in a computer-readable medium for providing display information for display by an end user display device, the program comprising:
instructions for receiving multimedia content;
instructions for determining at least one display point within the received multimedia content;
instructions for executing at least one display application, wherein the display application provides display information configured for display on the end user display device; and
instructions for blending the display information with the received multimedia content, based on the display points within the multimedia content, for display on the end user display device.

2. The computer program as recited in claim 1, wherein the received multimedia content is configured to include at least one transition point therein, wherein the determining instructions include determining transition points within the multimedia content, and wherein the blending instructions include blending the display information with the multimedia content based on at least one of the transition points within the multimedia content.

3. The computer program as recited in claim 1, wherein the received multimedia content is encoded with at least one tag that identifies at least one display point in the multimedia content, wherein the determining instructions include locating the at least one tag in the multimedia content, and wherein the blending instructions include blending the display information with the decoded multimedia content based on at least one of the tags encoded in the multimedia content.

4. The computer program as recited in claim 1, wherein the end user can initiate at least one triggering event associated with the multimedia content, and wherein the blending instructions include blending the display information with the decoded multimedia content in response to the at least one triggering event.

5. The computer program as recited in claim 1, wherein the blending instructions include instructions for processing the received multimedia content in such a way that at least one display point is created in the multimedia content, and wherein the display information is blended with the multimedia content at the at least one display point.

6. The computer program as recited in claim 1, wherein the multimedia content is received by a video processing device, and wherein the program further comprises instructions for loading at least one display application on the video processing device.

7. The computer program as recited in claim 1, further comprising instructions for decoding the received multimedia content in such a way that the decoded multimedia content is configured for display on the end user display device.

8. The computer program as recited in claim 1, wherein the display information includes at least one type of information selected from the group consisting of a news information headline, a news information icon, a weather information headline, a weather information icon, a sports information headline, a sports information icon, at least one stock quote, a message indicator headline and a message indicator icon.

9. The computer program as recited in claim 1, further comprising instructions for transmitting the combined display information and multimedia content to the end user display device.

10. A device for providing display information for display on an end user display device, comprising:
a processor configured to receive multimedia content from a multimedia content source;
a display application manager coupled to the processor for executing at least one display application in such a way that the display application receives display information configured for display on the end user display device,
wherein at least one of the processor and the display application manager is configured to identify display points in the received multimedia content; and
a blender coupled to the processor and coupled to the display application manager for blending display information with multimedia content for display on the end user display device, wherein the display information is blended with the multimedia content based on the display points in the multimedia content.

11. The device as recited in claim 10, wherein the received multimedia content can include at least one transition point therein, wherein at least one of the processor and the display application manager is configured to identify transition points in the received multimedia content, and wherein the blender blends the display information with the multimedia content based on the transition points in the multimedia content.

12. The device as recited in claim 10, wherein the received multimedia content can be encoded with at least one tag that identifies at least one display point in the multimedia content, and wherein at least one of the processor and the display application manager is configured to identify tags in the received multimedia content.

13. The device as recited in claim 10, wherein the processor is configured to generate at least one display point in the received multimedia content in response to at least one instruction from an end user.

14. The device as recited in claim 10, wherein the display application manager is configured to receive display information from at least one of the processor via the received multimedia content and an external source of display information coupled to the display application manager.

15. The device as recited in claim 10, further comprising at least one memory element coupled to the processor for storing multimedia content received by the device.

16. The device as recited in claim 10, further comprising a decoder coupled to the processor for decoding the received multimedia content in such a way that the decoded multimedia content is configured for display on the end user display device.

17. The device as recited in claim 10, wherein at least a portion of the device is contained in a video processing device.

18. The device as recited in claim 17, wherein the video processing device is selected from the group consisting of a signal converter box, a signal decoder box, a digital video recorder, a digital video disk recorder, a personal video recorder device, a home media server, a digital video server, a residential gateway, a video receiver and a computer.

19. The device as recited in claim 10, wherein the device is configured to transmit multimedia content combined with display information to the end user display device.
